(19) United States
(12) Patent Application Publication
(10) Pub. No.: US 2008/0219823 A1
(43) Pub. Date: Sep. 11, 2008

(54) LIFTGATE MOUNT ASSEMBLY WITH RETRACTABLE PIN INTERFACE

(76) Inventors: Dane W. Gregg, Uniontown, OH (US); Peter J. Savoy, Akron, OH (US)

Correspondence Address: BROUSE MCDOWELL LPA, 388 SOUTH MAIN STREET, SUITE 500, AKRON, OH, 44311, US

(21) Appl. No.: 11/854,060

(22) Filed: Sep. 12, 2007

Related U.S. Application Data
(60) Provisional application No. 60/825,487, filed on Sep. 13, 2006.

(51) Int. Cl. B60P 1/44

(52) U.S. Cl. 414/557

(57) ABSTRACT

A liftgate assembly may include a mount assembly for use in mounting the liftgate assembly to an associated vehicle. The mount assembly may include a mounting structure that has: (a) first and second beams where the first beam has a first opening; (b) a cross member operatively connected to the first and second beams; and, (c) a retractable pin mechanism including a first pin that can be extended through the first opening in the first beam and through a first opening formed in an associated vehicle to secure the liftgate assembly to the associated vehicle.

This application claims priority from U.S. provisional patent application Ser. No. 60/825,487 titled LIFTGATE MOUNT ASSEMBLY WITH RETRACTABLE PIN INTERFACE filed on Sep. 13, 2006, which is incorporated herein by reference.

### I. BACKGROUND OF THE INVENTION

A. Field of Invention

This invention pertains to the art of methods and apparatuses regarding liftgates and more specifically to methods and apparatuses regarding mounting a liftgate to a vehicle.

B. Description of the Related Art

It is well known in the art to attach liftgates to vehicle trailers or other forms of vehicle cargo holds to assist with loading and unloading of the vehicles. In general, liftgates include a platform and some motorized system, often including a hydraulic system, used to move the platform. To load cargo from a ground surface to the vehicle bed, the platform is positioned in a lowered position where it is generally parallel with the ground surface. The cargo can then be easily placed onto the platform. The platform is then lifted to a raised position generally parallel with the vehicle bed. The cargo can then be easily loaded into the vehicle. To unload cargo from the vehicle, the reverse steps are taken.

Various types and styles of liftgates are known in the art. Some non-limiting examples include conventional liftgates, flip-a-way or fold-up liftgates, and rail type liftgates. Some liftgates are designed to attached to the back of a vehicle, such as a truck or trailer, while others are designed to attach to the side of a vehicle. In every case, it is important to carefully mount the liftgate to the vehicle so that the liftgate operates properly without binding or unwanted interference.

Known difficulties related to mounting liftgates to vehicles include the relatively large weights of liftgates and the importance of proper alignment of the liftgate with respect to the vehicle. FIGS. 1a and 1b, for example, illustrate one known method for mounting a liftgate to a vehicle.

With reference to FIG. 1a, typical instructions for the installation of the mount frame may be as follows: “Mark the centerline of the platform. Unfasten the outboard ends of the cylinders from the lift arms. Assemble the counterweight as shown using channels or angles as supports. Line up the center of the platform with the center of the bed extension. Make sure that the skin of the platform is tight against the bed extension as shown at arrow “B.” Clamp the main platform securely to the supports. Note that the platform must be level with the truck floor. Raise the mount tube to do the “A” dimension. When correctly positioned, the parallel arms must be fully extended. The top surface of the mount tube should be approximately parallel with the truck floor. Note: be sure the center lines of the bed extension and the platform are in line.”

With reference to FIG. 1b, typical instructions for the installation of the mount plate may be as follows: “Locate the mount plates on the mount tube. The mount plates should be approximately 90° with respect to the vehicle frame. Check that the mount plates extend a minimum of 5¼ inches above the bottom of the vehicle frame. Recheck the “A” dimension. Weld the three sides of the mount plates 100% to the vehicle frame. Weld the mount tube to the mount plates. Weld all around both sides of the mount plates and ends.”

Note that the instructions just provided require the direct welding of the mount plates directly to the vehicle frame. Note also that proper alignment, especially side to side alignment, requires careful attention because the mount plates are independently attached to opposite sides of the vehicle frame. Once the mount plates are attached, the mount tube is then welded to the mount plates. Once again, care must be used to be sure that the mount tube is properly side to side aligned prior to this welding.

The present invention provides methods and apparatuses for easily and accurately mounting a liftgate to a vehicle and thereby greatly minimizes the foregoing difficulties and others while providing better and more advantageous overall results.

### II. SUMMARY OF THE INVENTION

According to one embodiment of this invention, a liftgate assembly comprises: a platform assembly comprising a platform having a traffic surface for use in receiving traffic for loading and unloading cargo; a lift assembly for use in moving the platform between a lowered position and a raised position; and, a mount assembly for use in mounting the liftgate assembly to an associated vehicle. The mount assembly includes a mounting structure that comprises: (a) first and second beams wherein at least the first beam has a first opening; (b) at least one cross member operatively connected to the first and second beams; and, (c) a retractable pin mechanism comprising a first pin that can be extended through the first opening in the first beam and through a first opening formed in the associated vehicle to secure the liftgate assembly to the associated vehicle.

According to another embodiment of this invention, a method comprising the steps of:

providing a liftgate assembly comprising: a platform assembly comprising a platform having a traffic surface for use in receiving traffic for loading and unloading cargo; a lift assembly for use in moving the platform between a lowered position and a raised position; and, a mount assembly for use in mounting the liftgate assembly to an associated vehicle, the mount assembly including a mounting structure that comprises: (a) first and second beams wherein at least the first beam has a first opening; (b) at least one cross member operatively connected to the first and second beams; and, (c) a retractable pin mechanism comprising a first pin; and,

extending the first pin through the first opening in the first beam and through a first opening formed in a first rail on an associated vehicle to secure the liftgate assembly to the associated vehicle.

According to another embodiment of this invention, the method also comprises the step of: positioning the mount structure with respect to the first rail on the associated vehicle such that the first opening in the first beam is aligned with the first opening in the vehicle rail.

One advantage of this invention, is that a liftgate can be easily mounted to a vehicle without direct welding.

According to another advantage of this invention, is that a liftgate can be easily aligned with respect to a vehicle.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1a illustrates a prior art method of installing a liftgate mount frame.

FIG. 1b illustrates a prior art method of installing a liftgate mount plate.

FIG. 2 is a perspective view of a liftgate assembly.

FIG. 3 is a perspective view of a mount assembly according to one embodiment of this invention.

FIG. 4 is a back view of a vehicle equipped with the mount assembly of this invention.

FIG. 5 is an enlarged fragmentary view taken from the area encircled by broken lines in FIG. 4.

FIG. 6 is an enlarged sectional view taken along lines 6-6 from FIG. 5.

FIG. 7 is an enlarged fragmentary sectional view of another embodiment of a locking pin.

FIG. 8 is a view similar to that shown in FIG. 7 but showing the pin in a fully extended, locked position.

FIG. 9 is a view similar to FIG. 8 but showing the pin in a slightly retracted position.

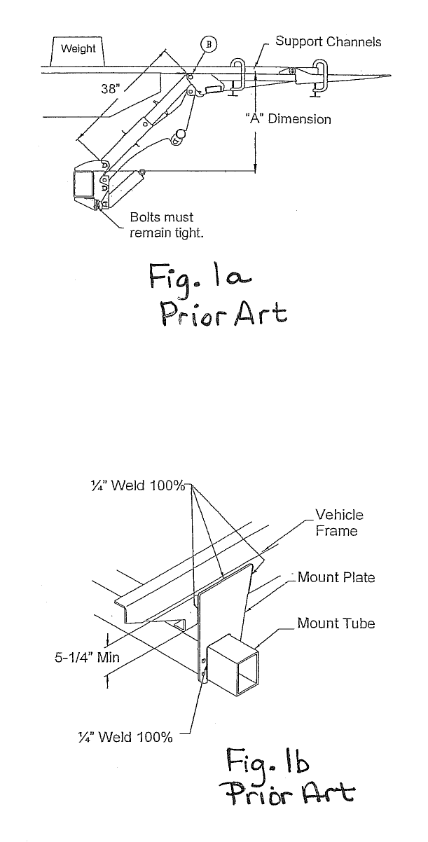

### IV. DETAILED DESCRIPTION OF THE INVENTION

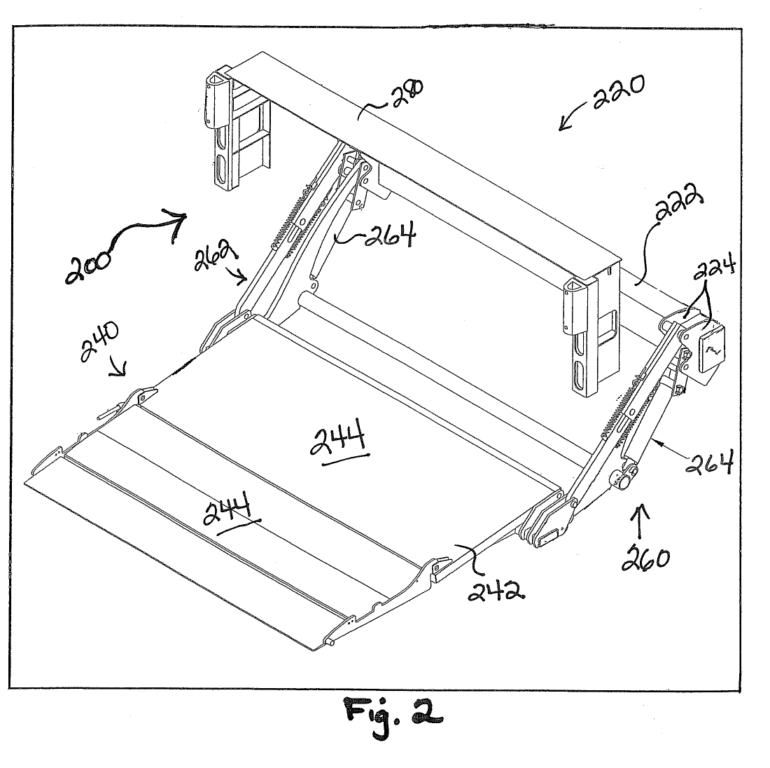

Referring now to the drawings wherein the showings are for purposes of illustrating embodiments of the invention only and not for purposes of limiting the same, FIG. 2 shows a liftgate assembly 200 that may include: a mount assembly 220 having a mounting structure 20 according to this invention; a platform assembly 240 having a platform or deck 242; a lift assembly 260; and a bed extension 280. The platform or deck 242 may include one or more generally planar sheet or plate members having a traffic surface 244 adapted to receive traffic for loading and unloading cargo. The lift assembly 260 is used to move the platform assembly 240 between a lowered position (shown in FIG. 2) a raised position (not shown but well known in the art) and, in one embodiment, a folded or storage position (also not shown but well known in the art). The lift assembly 260 may include a lift arm assembly 262 which attaches the platform assembly 240 to the mount assembly 220. The lift assembly 260 may also include a power system that may include a pair of hydraulic cylinders 264, and a control system (not shown). The basic operation of the lift assembly 260 is well known and will not be described in detail. The mount assembly 220 may be used to mount the liftgate assembly 200 to a vehicle 40 as will be described further below. The mount assembly 220 may include a mount tube 222 that may have, in one embodiment, one or more mount brackets 224 for attachment to the lift arm assembly 264 in any manner chosen with sound engineering judgment. In another embodiment, the lift arm assembly 264 may attach directly to the mount tube 222. While the liftgate assembly 200 shown is the style known as flip-a-way or fold-up, it is to be noted that this invention will work with any liftgate style, type and size, when applied with sound engineering judgment.

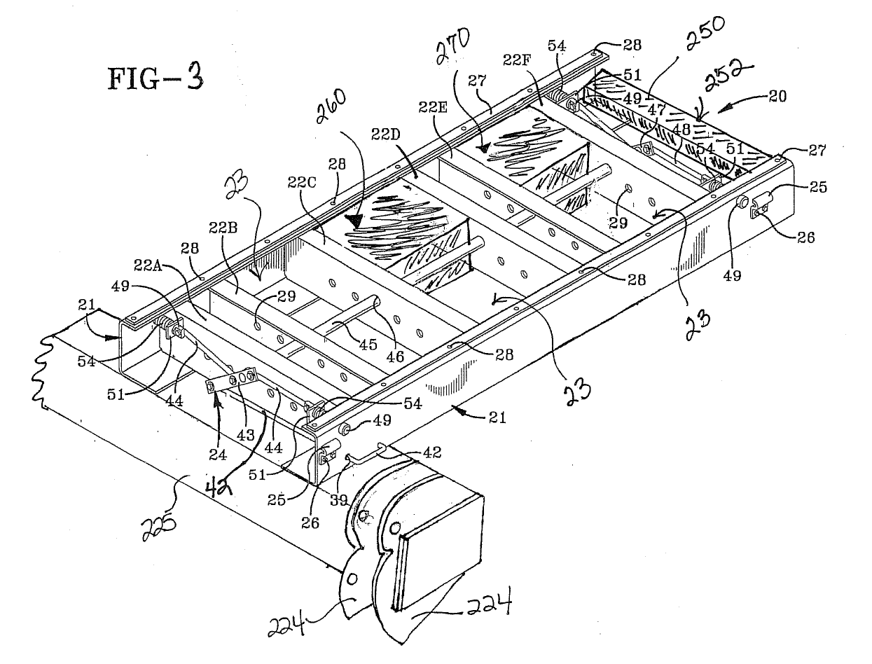

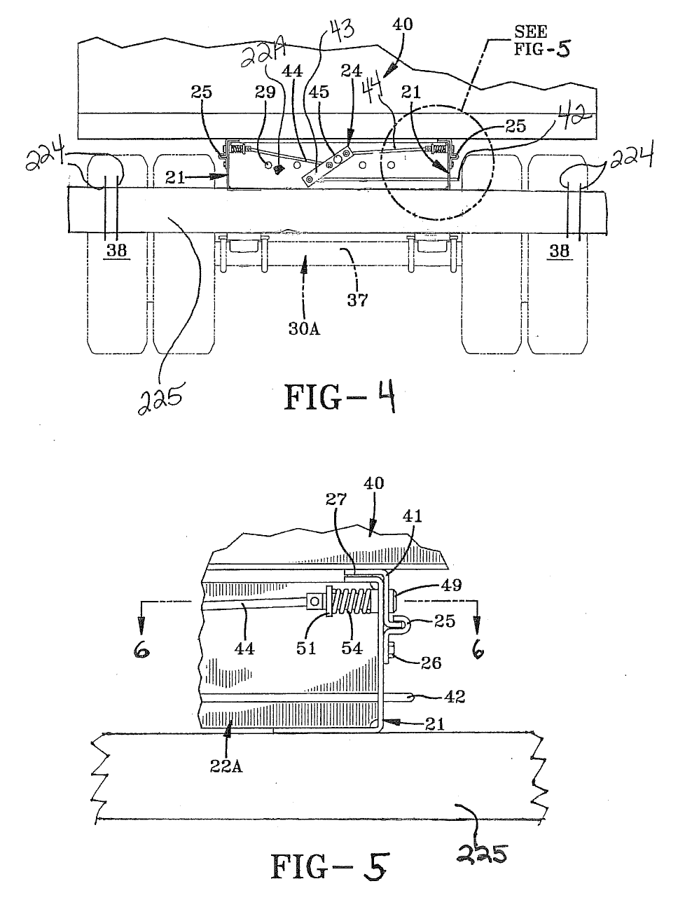

With reference now to FIGS. 3-5, the mount assembly 220 may include a mounting structure 20 that may be attached to the vehicle 40, see FIG. 4, as will be discussed further below. While the vehicle shown is a trailer body 40, it is to be understood that the mounting structure 20 of this invention will work with any vehicle when applied with sound engineering judgment. Mounting structure 20 includes a pair of main members 21, a plurality of cross members 22A-F, and a retractable pin mechanism 24 that is used to secure the liftgate assembly to the vehicle 40. Each main member 21 may be an elongated, generally C-shaped beam made of a metal such as steel or other suitable material. However, beams of other shapes chosen with sound engineering judgment may also work well with this invention. The open portion of each main member 21 is opposed to the open portion of the other main member and faces inboard relative to mounting structure 20. Main members 21 are connected to each other in spaced apart parallel relationship by cross members 22A-F, which extend between and are generally perpendicular to the main members 21. Each end of each cross member 22 may nest in the open portion of a respective one of main members 21, and may be secured therein by any suitable means such as welding or mechanical fastening. Each cross member 22 is a generally C-shaped beam made of a metal such as steel or other suitable material, and has a plurality of openings 29 formed in its vertically extending surface. However, beams of other shapes chosen with sound engineering judgment may also work well with this invention. Openings 29 may be aligned with corresponding openings formed in the other cross members 22 to provide for passage of air and/or fluid conduits, electrical lines, and the like, used in the operation of the tractor-trailer (not shown). Zones 23, between the cross members 22, may be advantageously used to hold liftgate assembly components, such as a battery pack 260, a power supply 270, or any other auxiliary equipment. The mount tube 222 may be attached by welding or other suitable means, to the lowermost surfaces of the main members 21 at any location along the length of the mounting structure 20 in accordance with the particular liftgate and vehicle. It should be appreciated that the mounting structure 20 may be used as a self contained unit.

With continuing reference to FIGS. 3-5, each main member 21 may have a pair of rail guides 25 mounted on its outboard surface by bolts 26. Each rail guide 25 is mounted adjacent to a respective one of the ends of main member 21. A low friction strip 27 may be attached to the uppermost surface of each main member 21 by recessed fasteners 28, and may extend generally the entire length of main member 21. Strip 27 may be formed of any suitable low friction material, such as ultra-high molecular weight polyethylene.

With reference now to FIGS. 3-6, the mounting structure 20 is movably mounted on the vehicle 40 by slidable engagement of rail guides 25 with spaced apart, parallel, and generally Z-shaped rails 41, which are mounted on and depend from the underside of the vehicle 40. This invention will work equally well with vehicle rails of other shapes provided the rail guides 25 are correspondingly adjusted. Each low friction strip 27 abuts the bottom surface of the uppermost portion of a respective one of rails 41 to provide a smooth, generally friction-free contact surface for slidable movement of the mounting structure 20 under the vehicle 40. The mounting structure 20 can be selectively positioned relative to the vehicle 40 for optimum liftgate alignment by the retractable pin mechanism 24. The pin mechanism 24 may include, in one embodiment, a generally L-shaped handle 42, which passes through an opening 39 formed in a selected one of main members 21. It can be seen that the bent end portion of handle 42 which extends outwardly from the outboard side of main member 21, is accessible for easy grasping by an operator. The inboard end of handle 42 is pivotally attached to a lever 43, which in turn is pivotally attached to a pair of arms 44 which extend in opposite outboard directions from lever 43. Lever 43 further is attached to an elongated pivot rod 45 which passes rearwardly through a plurality of aligned openings 46 formed in cross members 22. The end of pivot rod 45 remote from lever 43 is similarly attached to a remote lever 47, which in turn is pivotally attached to a pair of arms 48 which extend in opposite outboard directions from lever 47. The outboard end of each of arms 44, 48 is bent and is pivotally attached to the inboard end of a locking pin 49. In other embodiments, rather than a manual system for movement and locking of the mounting structure 20, a pneumatic or hydraulic system could be used.

With continuing reference to FIGS. 3-6, the inboard end of each locking pin 49 may be slidably mounted in an opening 50 formed in a bracket 51 which is attached by suitable means such as welding to a respective one of cross members 22A and 22F. The enlarged cylindrical outboard end of each pin 49 passes through an opening 52 formed in a respective one of main members 21. When it is desired to lock mounting structure 20 in a selected position relative to vehicle 40 for proper alignment of the liftgate assembly, main member openings 52 are aligned with selected ones of a plurality of correspondingly sized openings 53 formed in rails 41 of the vehicle. Each pin 49 automatically extends through the selected aligned openings 52, 53 since the pin is biased in an outboard direction by a coil spring 54 captured between bracket 51 and the enlarged outboard end of pin 49. If it is desired by the operator to move the mounting structure 20 beneath vehicle 40 to better align the mount tube 222 (and thus the liftgate assembly) with respect to the vehicle 40, handle 42 is pulled in an outboard direction to retract pins 49 out of rail openings 53 and against the bias of spring 54, and mounting structure 20 is moved longitudinally along rails 41 until main member openings 52 align with selected rail openings 53 and locking pins 49 engage therewith as described hereinabove.

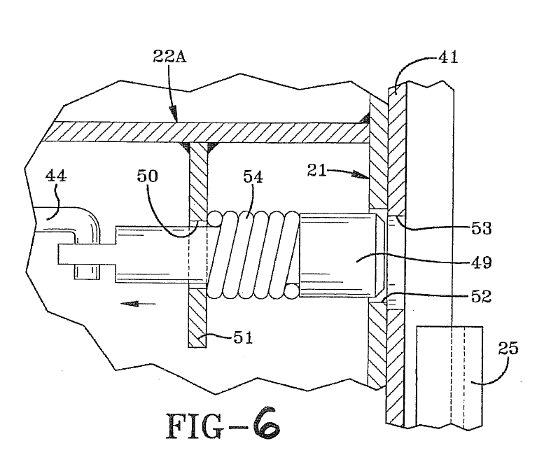

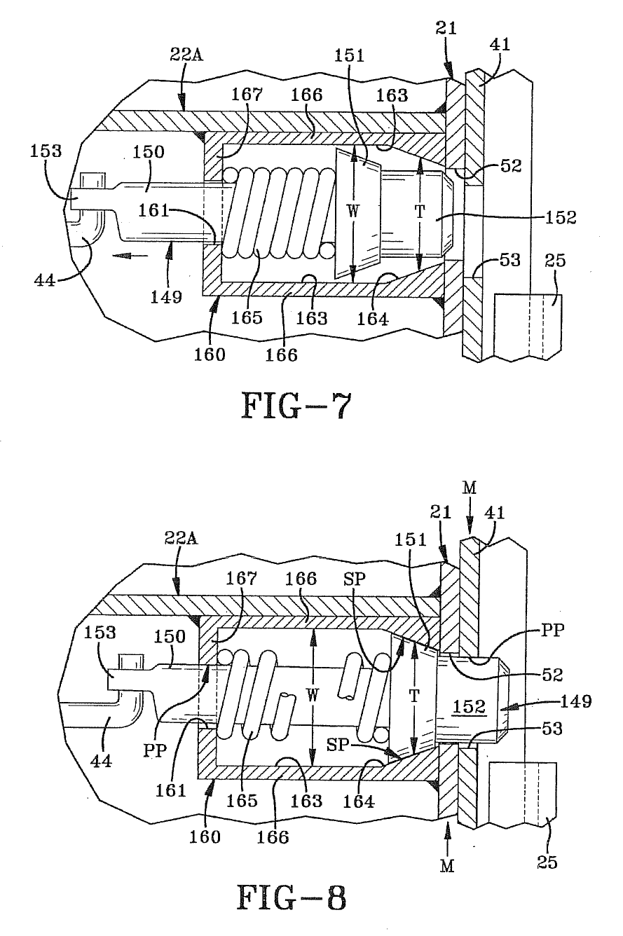

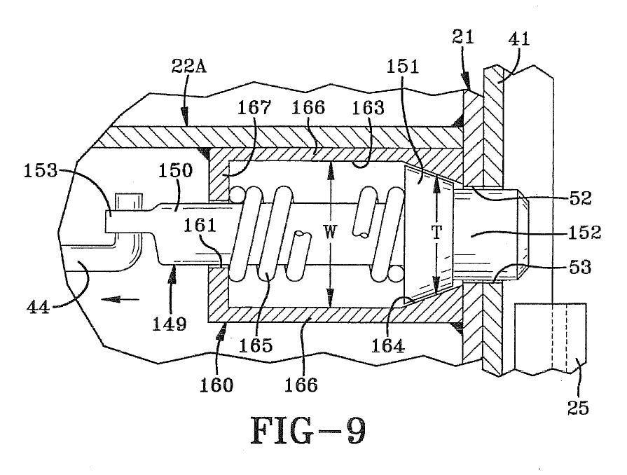

With reference now to FIGS. 7-9, another embodiment locking pin for a retractable pin mechanism with a mount assembly is indicated generally at 149. The environment in which locking pin 149 operates to attach a liftgate to a vehicle is generally identical to that described above for locking pin 49, including mounting structure 20 and retractable pin mechanism 24, with the differences in structure and operation between them being particularly described as follows. Pin 149 is formed of any sturdy material, preferably steel, and includes an elongated generally cylindrical-shaped base 150. In one embodiment, the outboard end of pin base 150 is integrally formed with an increased diameter tapered or truncated conical-shaped portion 151. The inboard end of truncated conical portion 151 has a larger diameter than its outboard end. Truncated conical portion 151 is in turn integrally formed with a generally cylindrical-shaped outboard end portion 152. Outboard end portion 152 has a diameter larger than base 150, and slightly smaller than the outboard end of truncated conical portion 151. Moreover, the diameter of outboard end portion 152 is generally the same as that of the enlarged cylindrical outboard end of pins 49 (see FIG. 6). The inboard end of base 150 is integrally formed with a stud 153. An opening (not shown) is formed in stud 153 for pivotally receiving the bent end of a respective one of arms 44, 48 of retractable pin mechanism 24, thereby connecting locking pins 149 to the remainder of the mechanism.

With continuing reference to FIGS. 7-9, pin 149 is partially contained in a generally rectangular-shaped enclosure 160 which is formed of any durable material, preferably steel. Each enclosure 160 is attached to a respective one of cross members 22A-F and a respective one of main members 21 of mounting structure 20 by any suitable means such as welding. Enclosure 160 includes a pair of side walls 166 and an inboard wall 167. An opening 161 is formed in inboard wall 167 of enclosure 160, and has a diameter slightly larger than that of pin base 150 which passes through the opening. In another embodiment, the interior of enclosure 160 includes an inboard section 163 having a width W which is slightly larger than the largest diameter of truncated conical portion 151 of pin 149, and extends the majority of the length of enclosure 160 to allow for travel of the pin within the enclosure as will be set forth in detail below in the description of the operation of pin 149. The outboard section 164 of enclosure 160 has a tapering width T which tapers from the width of inboard section 163 to the width of mount assembly main member opening 52, and generally corresponds to the tapering diameter of truncated conical portion 151 of pin 149. Outboard section 164 entirely surrounds pin 149 (not shown) to allow for full and stable nesting of tapered portion 151 therein as will be described below. However, enclosure 160 is otherwise open so that pin 149 is accessible for maintenance and the like and to prevent the enclosure from collecting debris. A coiled spring 165 is disposed about base 150 of pin 149 and is captured between inboard wall 167 of enclosure 160 and truncated conical portion 151 of pin 149. Spring 165 biases pin 149 in an outboard, extended or locked position.

With reference now to FIG. 3, while the use of a retractable pin mechanism has been described above as one embodiment mechanism for selectively attaching the of mounting structure 20 to the vehicle rails 41, it should be understood that other mechanisms will also work with this invention. A series of bolts, for example, could be used. In another embodiment, a large washer could be used with the bolts to ensure the proper torque. In yet another embodiment, a sheer nut or a sheet head bolt could be used to ensure the proper torque without the use of a torque wrench. In another embodiment, a cammed washer could be used to ensure proper alignment. These various attaching mechanisms could also be combined with the use of, for example, a pair of retractable pins and a pair of bolts.

With reference now to FIGS. 3-5, it is well known for tractor trailers to use a sub-frame, known as a slider, that can move within the rails 41 of the trailer. An example of a slider is provided in U.S. Pat. No. 5,642,896. Because the mounting structure 20 of this invention may be attached to the same rails 41, there exists the possibility that a slider could be inadvertently moved into the mounting structure 20. To protect against this contact, the mounting structure 20 may be equipped with a stop member 250. The stop member 250, which may extend outward beyond the ends of the beams 21, may have a contact surface 252 adapted to contact a slider. The contact surface 252 may be a strip of material added to the stop member 250 and may be formed of any suitable force dampening material. In one embodiment, shown in FIG. 3, the stop member 250 is attached to the inner surfaces of the beams 21. In another embodiment, the stop member 250 is attached not to the mounting structure 20 but rather to the rails 41. With this embodiment, the stop member acts as a protective shield between the mounting structure 20 and the slider. The shape of the stop member and the materials used to form it can be any chosen with sound engineering judgment.

Having thus described the invention, it is now claimed:

I/We claim:

1. A liftgate assembly comprising:
a platform assembly comprising a platform having a traffic surface for use in receiving traffic for loading and unloading cargo;
a lift assembly for use in moving the platform between a lowered position and a raised position; and,
a mount assembly for use in mounting the liftgate assembly to an associated vehicle, the mount assembly including a mounting structure that comprises:
(a) first and second beams wherein at least the first beam has a first opening;
(b) at least one cross member operatively connected to the first and second beams; and,
(c) a retractable pin mechanism comprising a first pin that can be extended through the first opening in the first beam and through a first opening formed in the associated vehicle to secure the liftgate assembly to the associated vehicle.

2. The liftgate assembly of claim 1 wherein:
the mounting structure further comprises a second opening in the second beam; and,
the retractable pin mechanism further comprises a second pin that can be extended through the second opening in the second beam and through a second opening formed in the associated vehicle to secure the liftgate assembly to the associated vehicle.

3. The liftgate assembly of claim 1 wherein the mounting structure further comprises:
a zone positioned between the first and second beams that holds at least one liftgate assembly component.

4. The liftgate assembly of claim 3 wherein the liftgate assembly component is a battery pack.

5. The liftgate assembly of claim 3 wherein the liftgate assembly component is a power supply.

6. The liftgate assembly of claim 1 wherein the mounting structure further comprises:
a stop member that extends outward beyond the ends of the first and second beams for use in contacting a slider.

7. The liftgate assembly of claim 6 wherein the stop member is attached to inner surfaces of the first and second beams.

8. The liftgate assembly of claim 6 wherein the stop member has a contact surface formed of a force dampening material.

9. The liftgate assembly of claim 1 wherein:
the lift assembly comprises a pair of lift arms; and,
the mount assembly comprises a mount tube that is attached to the lift arms and to the first and second beams of the mounting structure.

10. The liftgate assembly of claim 9 wherein the mount tube is fixedly attached to bottom surfaces of the first and second beams.

11. A method comprising the steps of:
providing a liftgate assembly comprising: a platform assembly comprising a platform having a traffic surface for use in receiving traffic for loading and unloading cargo; a lift assembly for use in moving the platform between a lowered position and a raised position; and, a mount assembly for use in mounting the liftgate assembly to an associated vehicle, the mount assembly including a mounting structure that comprises: (a) first and second beams wherein at least the first beam has a first opening; (b) at least one cross member operatively connected to the first and second beams; and, (c) a retractable pin mechanism comprising a first pin;
extending the first pin through the first opening in the first beam and through a first opening formed in a first rail on an associated vehicle to secure the liftgate assembly to the associated vehicle.

12. The method of claim 11 wherein prior to the step of, extending the first pin through the first opening in the first beam and through a first opening formed in an associated vehicle to secure the liftgate assembly to the associated vehicle, the method comprises the step of:
positioning the mount structure with respect to the first rail on the associated vehicle such that the first opening in the first beam is aligned with the first opening in the vehicle rail.

13. The method of claim 11 further comprising the steps of:
providing the second beam with a second opening;
providing the retractable pin mechanism with a second pin; and,
extending the second pin through the second opening in the second beam and through a second opening formed in a second rail on the associated vehicle to secure the liftgate assembly to the associated vehicle.

14. The method of claim 11 further comprising the step of:
placing a battery pack within a zone positioned between the first and second beams.

15. The method of claim 11 further comprising the step of:
placing a power supply within a zone positioned between the first and second beams.

16. The method of claim 11 further comprising the steps of
providing the lift assembly with a pair of lift arms;
providing the mount assembly with a mount tube that is attached to the lift arms; and,
attaching the mount tube to the first and second beams of the mounting structure.
